(19) United States
(12) Patent Application Publication
(10) Pub. No.: US 2023/0256275 A1
(43) Pub. Date: Aug. 17, 2023

(54) Forest Fire Extinguisher and Prevention System and Method

(71) Applicant: Gustavo Velasquezfernandez, Floral Park, NY (US)

(72) Inventor: Gustavo Velasquezfernandez, Floral Park, NY (US)

(21) Appl. No.: 18/154,916

(22) Filed: Jan. 16, 2023

(51) Int. Cl. A62C 3/02

(52) U.S. Cl. CPC A62C 3/0271; A62C 3/0292

(57) ABSTRACT

A system and method for extinguishing and preventing a forest fire. This system consists of a forest fire detection device that detects a forest fire, collects data from the forest fire, transmit the data to either the fire department and/or an operator/user via a website, mobile app, or a control room, and alert the public of a forest fire commencing. This system also presents a spray device that consists of a head, sprayer, rotating mechanism, and a reservoir all working together as one to extinguish and prevent a forest fire.

The present invention relates to forest fire control and forest fire prevention. More particularly, the present invention is a system and method for extinguishing and preventing forest fires.

### FIELD OF THE INVENTION

The present invention relates to a forest fire extinguisher and prevention system. This invention particularly relates to a system and method for extinguishing and preventing forest fires.

### BACKGROUND OF THE INVENTION

Forest fires are a natural occurrence within some if not all forest ecosystems. Natural Forest Fires have a positive and negative effect towards the ecosystem. Some of the positive effects of natural forest fire are that it removes low-growing underbrush, cleans the forest floor of debris, creating room for the trees to receive sunlight and allow the trees to receive the nutrients the trees need to become stronger and healthier.

However, with the increase of uncontrollable forest fires occurring in recent years, it has negatively affected our planet in many ways. Forest fires are burning nearly twice as much trees cover today as they were 10-20 years ago. Forest fires have greatly impacted not only our o-zone layer, but also natural habitats, animals, reduction of trees, our homes, our lives, and our health. For example, the smoke and ash have greatly impacted those with any pre-existing respiratory diseases. Emergency response workers and firefighters are also greatly affected by smoke inhalation and burns. Forest fires have tragically claimed people's lives and destroyed their homes.

The negative impacts aren't restricted to just humans, but our native animals and plant life are also greatly affected by forest fires. Certain species of animals have been pushed to the verge of extinction by forest fires. For example, the already endangered California condor, is at the brink of extinction due to recent forest fires, by burning their homes and breeding grounds.

Another negative effect of forest fires is how it contributes negatively towards the o-zone layer and climate change, as well as the air quality we breathe.

Forest Fires have increasingly gained size, more widespread, and more frequent over the past 10-20 years. Comparing how frequent forest tires appear/occur in recent years, to the previous two decades, we know that the most extreme forest fires are now larger, more common, and more likely to join with other extreme forest fires. Fire seasons are not only becoming more prevalent, in areas where fire seasons are considered the norm such as California, but also in areas such as the Amazon, that are heavily affected by forest fires.

To this day there hasn't been a way to fully control, extinguish and prevent forest fires, let alone doing it in an eco-friendly manner. One of the methods that is used by California's fire department is by having helicopters fly over the forest fire and drop fresh water on top of forest fire. On average a helicopter can carry 00 to 3,000 gallons of freshwater. These helicopters can strategically drop thousands of gallons of freshwater, but at the same time it would take about two hours just for the first drop of water to arrive and nearly 5-6 hours for air tankers to drop fire retardant on the forest fire. Which isn't that effective to extinguish a forest fire, let alone environmentally safe for animals.

In addition, the negative aspect of using this method is the total time that is used while in the process of using helicopters to extinguish a forest fire. For example, take in consideration the time that it takes for each helicopter flying to and from the forest fire and the time it takes to refile a helicopter from each trip. As well as the time it takes for firefighters to prepare, strategize and the time for firefighters to reach the forest fire. Fire fighters may have protocols and/or strategies in place for situations or events of a forest fire, but forest fires are unpredictable and can happen at any given moment. Another negative aspect of using this method is the cost and use of jet fuel and the high-risk level pilots and firefighters are in when extinguishing a forest fire.

That method is dangerous for the pilots, firefighters, and has been proven to be slightly ineffective when fighting forest fires. The method was feasible in the past, but currently at this moment in time or submission of this patent application, forest fees are larger, more frequent, and more widespread compared to the records from past years.

Therefore, what is needed is a system and method to extinguish and prevent forest fires. A primary object of the present invention is to obviate the problems described above and to provide a simple, energy-efficient, eco-friendly method for the manufacture of the presented invention.

### BRIEF SUMMARY OF THE INVENTION

The presented invention may have the ability to extinguish and prevent a forest fire as well as warn and notify the public, the fire department, and/or an operator/user. This present invention detects a forest fire starting by either the forest fire detection device(s) and/or the spray device itself. The forest fire detection devices) may be placed within the diameter/max spraying distance (reach) of the spray device. The forest fire detection device(s), along with the spray device, may have the ability of simultaneously detecting a forest fire, gather/collect live data from the detected forest fire, store the collected data in a database, alert/notify the public, firefighters, and/or operator/user using a mobile app, website, and/or a control room. After the spray device and/or forest fire detection device communicates with the operator/user, the user may activate/command the spray device via the use of a website, mobile app, and/or control room and spray water onto the forest fire.

### BRIEF DESCRIPTION OF THE DRAWINGS

FIG. 1. Represents/Depicts an overview of the Forest Fire Extinguisher and Prevention System.

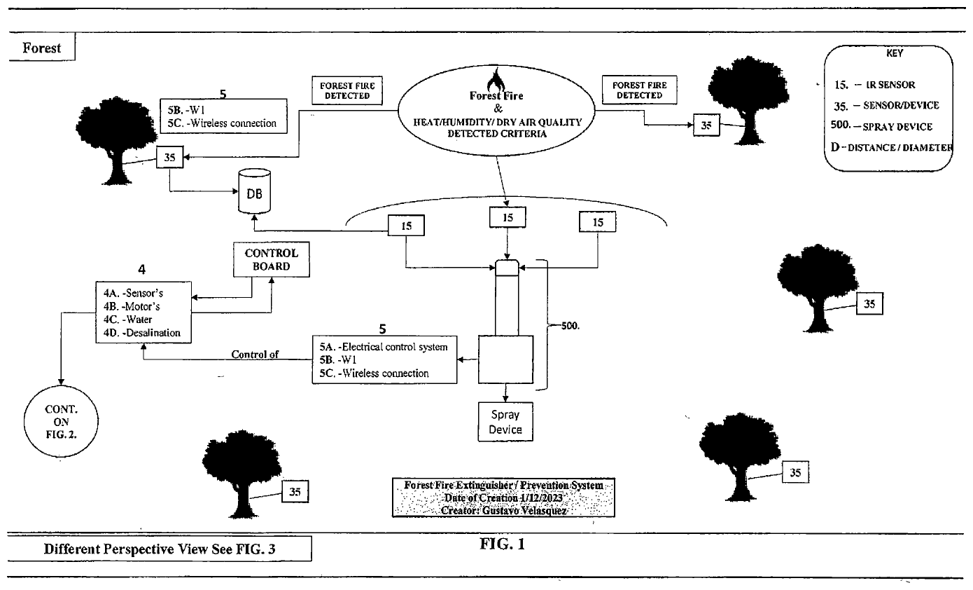

FIG. 2. Represents/Depicts an overview process of how data reaches a mobile device via mobile application.

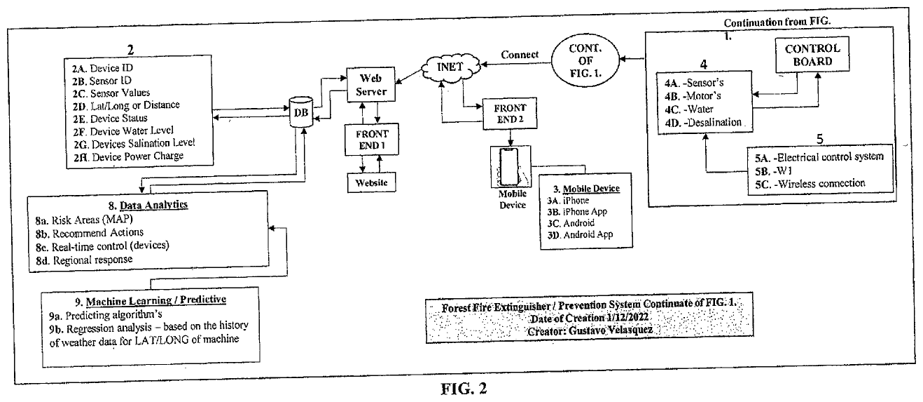

FIG. 3. Represents/Depicts the Forest Fire Extinguisher/Prevention system in a different perspective.

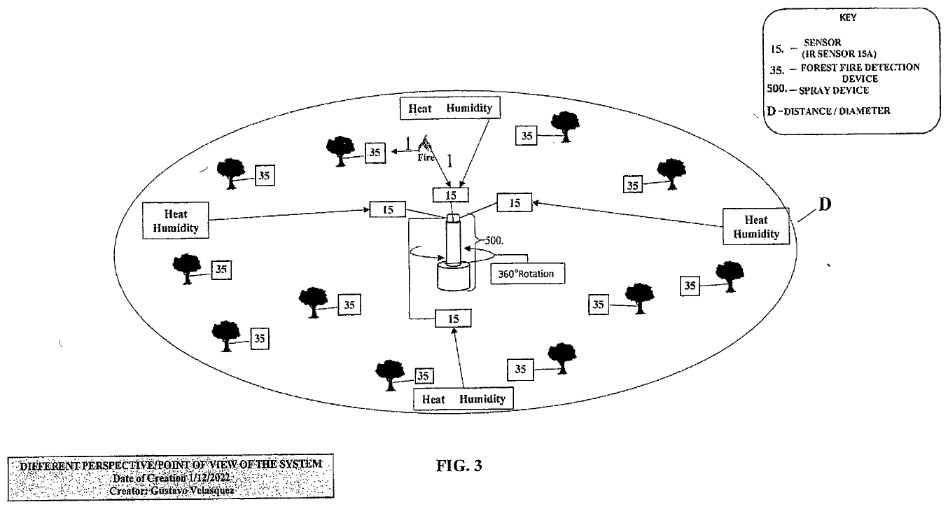

FIG. 4. Represents/Depicts the process of how a Mobile Interface may “ACT” on the information given from the system.

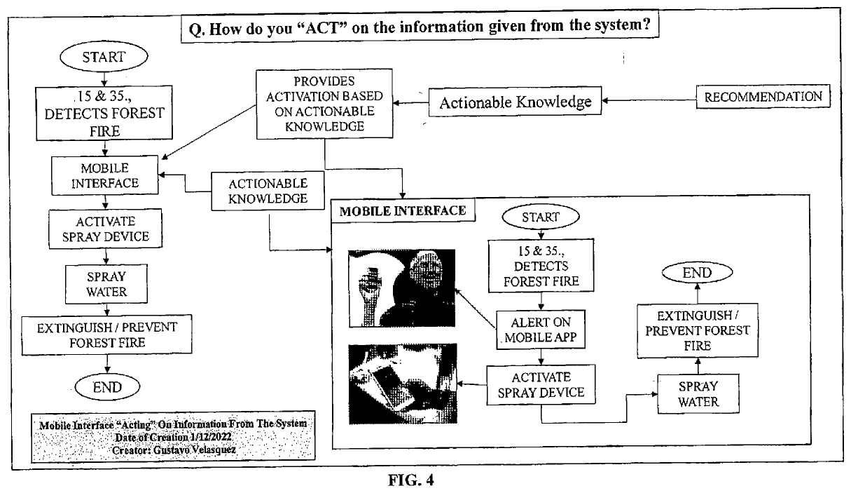

FIG. 5. Represents/Depicts a circular flow diagram of the energy/power cycle.

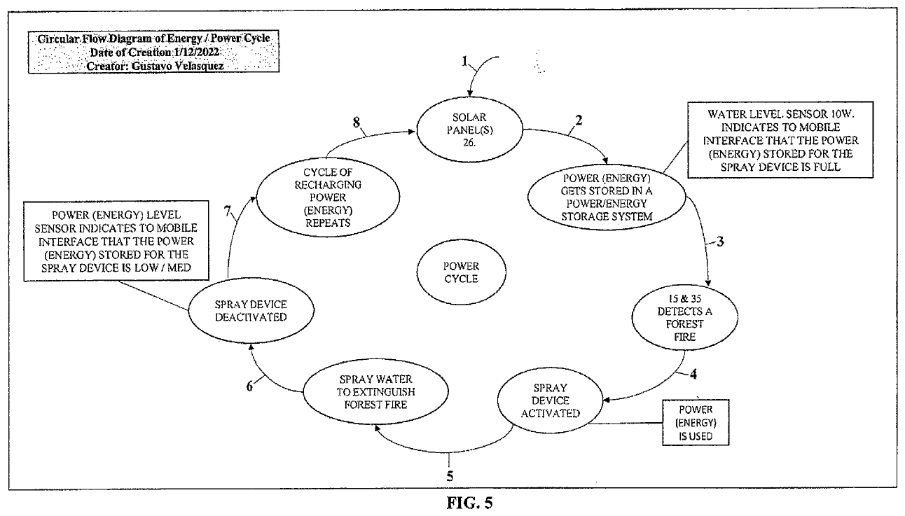

FIG. 6. Represents/Depicts an overview perspective of a spray device.

FIG. 7. Represents/Depicts the embodiments of the spray device and what may reside within each of the embodiments of the spray device. Additionally, the sensors that may be located within each of the embodiments.

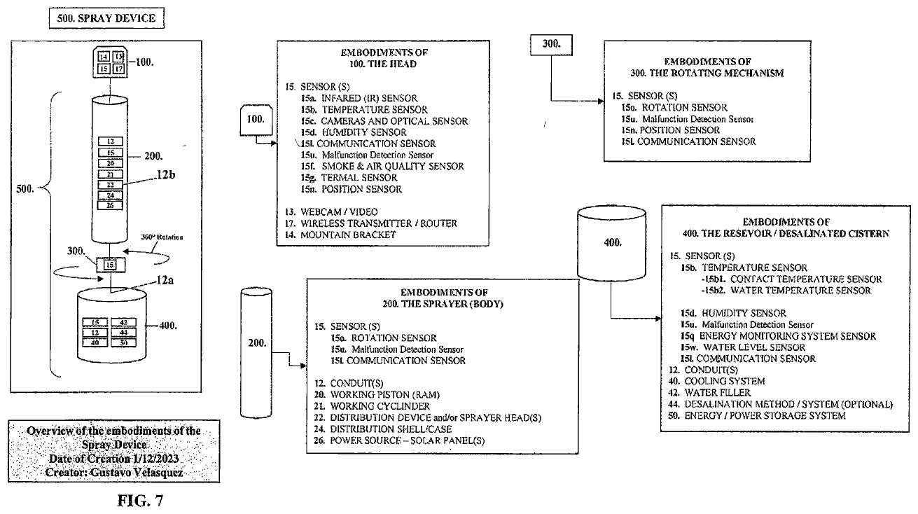

FIG. 8. Represents/Depicts the process of extinguishing a forest fire. 1, the forest fire detection devices detect the fire. 2A, simultaneously transmits live data gathered from the forest fire detection devices to the database. 2B simultaneously transmits the data from the database to send an alert and/or notification to either a control room directly and/or to a browser or mobile app. 3A and 3B demonstrate the 3 options that the operator has to activate the spray device. More specifically, 3B demonstrates how the public and fire fighters are able to get an alert/notification of the detected fire via a mobile app. 5, represents the operator's action/activation of the spray device, leading to 6, the activation of the spray device and the extinguishment of the detected fire.

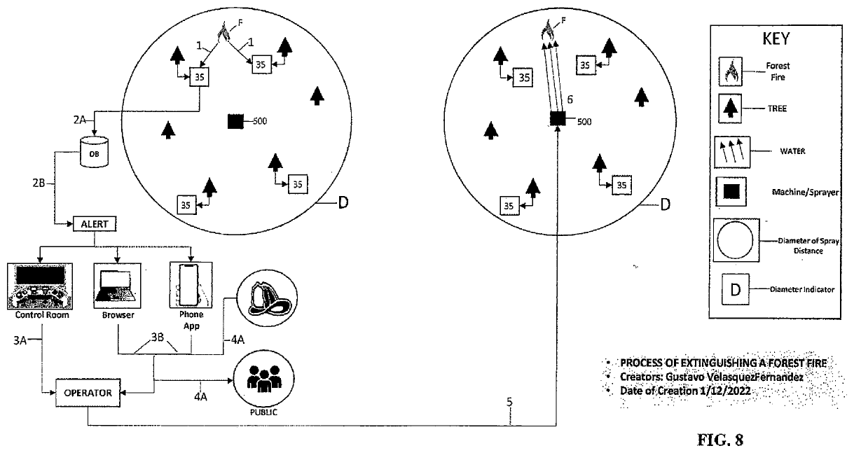

FIG. 9. Represents/Depicts the spray device in idle and the locations of the forest fire detection devices. FIG. 9 also demonstrates the distribution device(s)/sprayer head(s) that are located within the spray device from the top point of view.

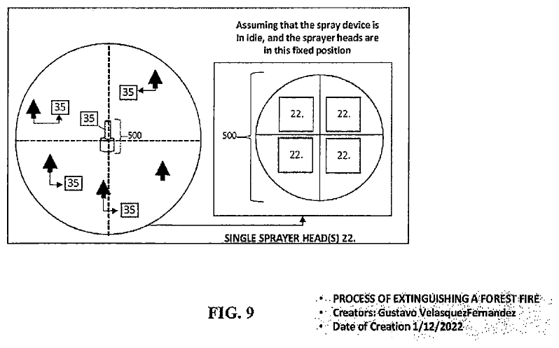

FIG. 10. Represents/Depicts the forest fire detection device(s) and/or spray device detecting a fire in the vicinity of one of the distribution device(s)/sprayer head(s) that are on the spray device. FIG. 10 also demonstrates the detection of a small fire. FIG. 10 also demonstrates only activating one of the distribution devices(s)/sprayer head(s) rather than using all the distribution device(s)/sprayer head(s). This would allow the conservation of power and water used to extinguish a forest fire/wildfire.

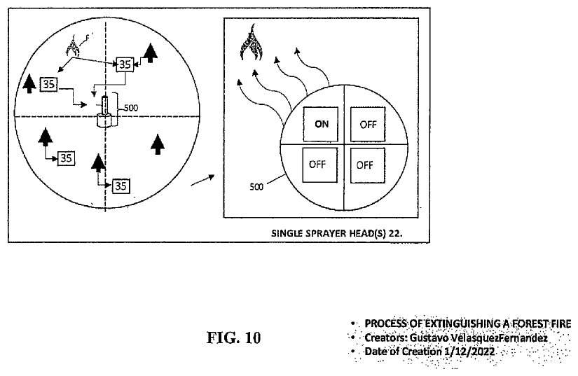

FIG. 11. Represents/Depicts the forest fire detection device(s) and/or spray device detecting a larger fire in the vicinity of one of the distribution device(s)/sprayer head(s) that are on the spray device. FIG. 11 demonstrates the use of two distribution devices)/sprayer head(s) working together, combining two active distribution device(s)/sprayer head(s) in order to extinguish the larger fire that was detected by the forest fire detection device(s) and/or spray device. FIG. 11 also demonstrates how the rotating mechanism works, by rotating the spray device to align the distribution device(s)/sprayer head(s) to the detected fire, in order to accurately extinguish the fire.

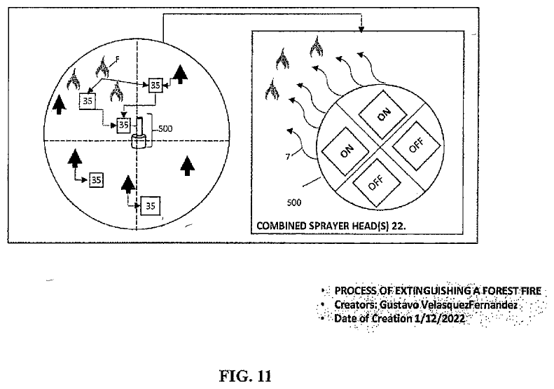

FIG. 12. Represents/Depicts a larger fire that has been detected in the vicinity of two distribution device(s)/sprayer head(s). FIG. 12 demonstrates the activation of two distribution device(s)/sprayer head(s) working together to extinguish the fire.

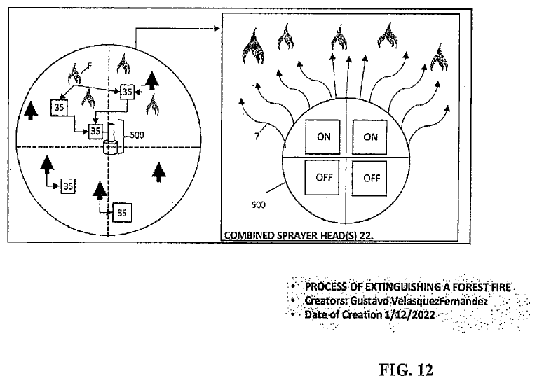

FIG. 13. Represents/Depicts the Malfunction Process. Whenever there's a malfunction of one of the distribution device(s)/sprayer head(s), FIG. 13 explains/demonstrates how the operator uses the rotating mechanism to rotate the malfunctioned distribution device/sprayer head away from its respected area. Replacing it with a functional/operational distribution device/sprayer head. Since the spray device informed the operator of the malfunction and the operator rotated and/or replaced the malfunctioned distribution device/sprayer head with a working distribution device/sprayer head, the malfunctioned distribution device/sprayer head waits until maintenance fixes the issue.

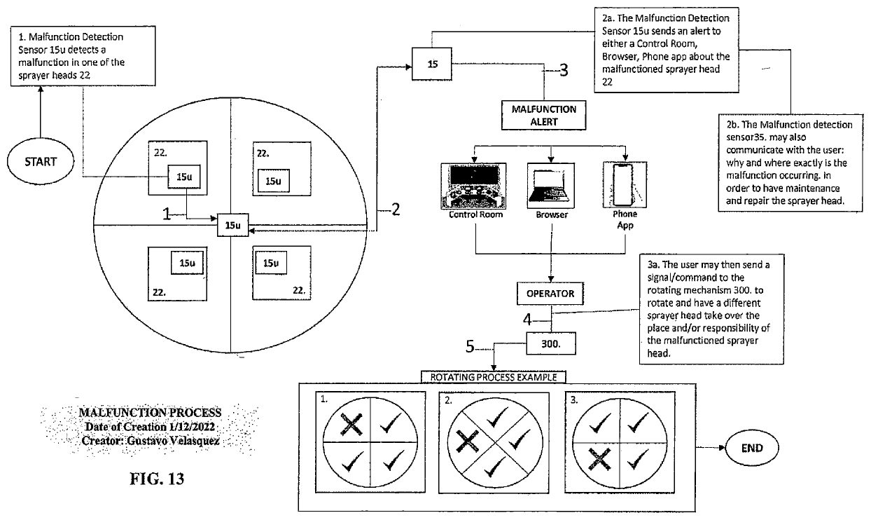

### SUMMARY OF THE INVENTION

The present invention relates to forest fire control. More particularly, a system and method of extinguishing and preventing forest fires and the spread of forest fires. The objective: Extinguishing and Preventing a forest fire from starting and from spreading to the rest of the forest.

### Preventative

The spray device 500 and/or the forest fire detection device 35 detects a forest fire commencing as well as using historical weather data to predict when certain weather conditions meet a that contributes to the likeliness of a forest fire occurring.

Since, fire season is defined as the time of year that wildfires are more likely to take place, due to the hot and dry climates. It leaves trees, grasses, and soil with very little moisture, making the landscape extremely flammable. Therefore, the importance of this system being able to detect when certain weather conditions contribute to the occurrence of a forest fire (Fire Season), is that it allows the spray device 500 to spray water onto the forest to hydrate the trees. This allows the forest to resist the occurrence and/or spread of a forest fire.

The forest fire detection device 35 and/or the spray device 500, may have the ability to detect a forest fire, by either a thermal heat signatures 15g, infrared (IR) sensors 15a, etc. When the forest fire detection device 35 and/or spray device 500, detects a forest fire, the forest fire detection device 35 and the spray device 500 may have the ability to send an alert to the public, the fire department, and/or the operator/user. The alert may be sent via a mobile app, website, or any other way that can communicate and alert the public, fire department, and/or the user.

The forest fire detection device 35 and/or the spray device 500, may collect/gather data from the finest fire such as the change of wind direction, change in direction of the forest fire, whether the forest fire is growing, etc. The collected data from both devices is transmitted and stored into a database. This allows the system to learn and become more accurate in detection of a forest fire, detection of weather conditions that meet a fire season criterion and provide recommendations to the user. The database may be viewed via a website, mobile, mobile app, etc. Additionally, the activation of the spray device 500 may be through a website, mobile app and/or control room.

This system 600 may have the ability to provide recommendations to the user. The recommendations are created and provided by combining the data from both devices. The system 600 may also have the ability to provide recommendations by using historical data, current/live data, and historical weather data. As well as the specific weather data that is collected and provided by each of the forest fire detection devices 35 and/or the spray device 500. When we are in a fire season, this system 600 may have the ability to depict when the humidity level reaches a certain point where forest fires are known to start and/or be more apparent on becoming uncontrollable, based on the historical weather data that already exist, but also by the weather data that is collected by the forest fire detection device 35. This allows the fire department and/or operator/user to activate the spray device 500 via a mobile app, website, and/or control room, onto the dry areas and/or forests, to moisturize the forest, preventing the spread of a forest fire, and preventing a forest fire from starting.

The goal is to have this system in place to extinguish current and future forest fires that are uncontrollable. As well as preventing them from occurring. The way that this system prevents a forest fire from occurring is by having this system placed in a certain location for years. In the long run, this system may reduce the number of forest fires occurring, as well as reducing the spread of the forest fire. “In the long run” means, after this system is in place, this system may have the ability of being used as a way to function as a forest fire prevention system, by generating electricity via solar panels 26, store the power via an energy/power storage system 500, use the energy that is stored to hydrate/moisturize the forest when fire season starts, or whenever the system 600 detects the temperature and/or air quality meeting the conditions or criteria for forest fires to likely to occur.

### Extinguisher

The current invention provides a solution to the problems addressed above. By placing multiple forest fire detection devices 35 in specific areas inside the perimeter and/or diameter. The perimeter/diameter is the max reach that a spray device has when spraying water.

The forest fire detection device 35 and the spray device 500 may have the ability of detecting a forest fire using one or a combination of sensors 15, such as: heat sensors 15h, infrared sensors 15a, smoke & ash detection sensor 15f, etc.

When a forest fire is detected by either a forest fire detection device 35 or the spray device 500, an alert is sent out to the public, fire department, and/or user. The alert may provide recommendations to the user on what appropriate action to take by the collected data from either/both the forest fire detection device 35 and the spray device 500. Combining the data provided by the forest fire detection device 35 and the spray device 500 this would allow the system 600 to recommend a better and more feasible way to extinguish a forest fire to the operator/user.

The data from the forest fire detection device 35, for example the location and movement of the forest fire helps the system better predict or determine how much water, power/energy, is needed to extinguish the forest fire. As well as providing the user what angle the spray device 500 spray water from. This allows the system to spray water directly to the forest fire, rather than spraying water in areas that are not on, fire. A benefit of this is that the user may have the ability to focus more water into extinguishing a forest fire and at the same time conserve the water that is not being used.

### Brief Description of the Embodiments of the System

A detailed description of the hereinafter described embodiments of the disclosed apparatus and method are presented herein by way of explanation and not limitation with reference to the figures listed above. Although certain embodiments are shown and described in detail, various changes and modifications may be made without departing from the scope of the appended claims. The scope of the present disclosure will in no way be limited to the number of constituting components, the materials thereof, the shape thereof, the relative arrangement thereof, etc., and are disclosed simply as an example of embodiments of the present disclosure.

Embodiments of a Forest Fire Extinguisher and Prevention System 600 may be comprised of a forest fire detection device 35, a Spray device 500, a wireless transmitter/router 17, Sensor(s) 15, a Power source 5, energy/power storage system 26, solar panels 25, and a mobile app.

### Detail Description of the Embodiments of the System

Embodiments of the Forest Fire Extinguisher and Prevention System 600 may further be comprised of a wireless transmitter/router 17. The location of router 17 may be in the forest fire detection device 35 And the spray device 500. The purpose of using a wireless transmitter/router 17 is that the wireless transmitter/router 17 provides access to the internet for the forest fire detection device 35 and the spray device 500. The wireless transmitter/router 17 has multiple uses such as giving the user the ability to view data and live readings from the forest fire detection device 35 and of the spray device 500, allow the notification or alert of a detected forest fire to the public, fire department, operator/user, and allowing the forest fire detection device 35 and the spray device 500 to communicate with the operator/user. A wireless transmitter/router 17 may provide a position sensor 15n the ability to function properly by providing the location of the spray device 500 as well as the location of the forest fire detection devices 35.

Embodiments of a Forest Fire Extinguisher and Prevention System 600 may comprise a power source 5. The power source 5 may be anything that may have the ability to provide energy/power to the system, and/or the ability to convert sunlight into electricity and/or power, such as solar panels 26. The power source 5 may further be comprised of one or more or combinations of Solar panels 26, rechargeable batteries, etc. For example, solar panels 26 in particularly, may be responsible for generating and providing power/electricity for this system. The system 600 may have one or more solar panel(s) 26, that may be placed around the exterior part of the spray device 500. For example, a solar panel(s) 26 may either be placed on the top section of a head 100, below the exit holes, where the distribution device(s)/sprayer head(s) 22 spray the water from, and/or around the sprayer 200 itself. The solar panel(s) 26 may have a protected clear case that can protect the solar panels 26 from anything that may potentially damage the solar panels 26. A benefit of using solar panels 26 and an energy/power storage system 50 is that the energy/power can be stored and may provide an “endless” supply of electricity/power to a spray device 500. The energy/power that is being generated from the solar panels 26 may be stored by using an energy/power storage system 50.

Embodiments of a Forest Fire Extinguisher and Prevention System 600 may comprised of an energy/power storage system 50. The energy/power storage system/unit/device 50 may comprise of one or more of a battery storage, or battery energy storage system(s) (BESS), residential photovoltaic (PV) system, electric battery bank, and/or any method that has the ability of storing energy/power.

Embodiments of a Forest Fire Extinguisher and Prevention System 600 may comprised a sensor(s) 15. A sensor 15 may comprised of one or more types of sensors. For example, this system may have a sensor 15 that is able to detect a forest fire either using a smoke and ash detection sensor 15f, a heat sensor 15h, an infrared (IR) sensor 15a, temperature sensor 15b, a thermal heat sensor 15g etc.

The system 600 may also be comprise of a humidity sensor 15d and an air quality sensor 15m for preventative measures.

The system 600 may also comprised of a temperature sensor 15b. A temperature sensor may have more than one purpose. For example, A temperature sensor 15b may have the ability to detect if the spray device 500 and the forest fire detection device 35 is overheating. A temperature sensor 15b may also have the ability of detecting if the temperature within the reservoir 400 is too warm/hot that the water that resides inside the reservoir 400 starts to evaporate.

The system 600 may also be comprised of a position sensor 15n to provide the location of each forest fire detection device 35 and the spray device 500.

The system 600 may also be comprised of a rotation sensor 15o to detect the rotation of the spray device 500 is complete, actively rotating, etc.

The system 600 may also be comprised of a communication sensor 15l. This sensor may be located on the forest fire detection devices 35, as well on each of the embodiments of the spray device 500. This allows the data of each embodiment of the spray device 500 to transmit the data to the mobile app. Which the user may have access to.

The system 600 may also be comprised of a malfunction detection sensor 15i. The malfunction detection sensor 15i, may have the ability of detecting any sort of malfunction occurring within the spray device 500 and the forest fire detection device 35.

The system 600 may also comprise of a water level sensor 15w. The water level sensor 15w may provide the user how much water is inside the reservoir 400.

The system 600 may also be comprised of an energy monitoring system sensor 15q. The energy monitoring system sensor 15q may have the ability of providing the user with a reading of how much energy/power is stored via the use of a mobile app or control room.

Some sensors may be used in both devices. For example, the forest fire detection device 35 and the spray device 500 may both have an infrared (IR) sensor 15a, to detect a forest fire.

Embodiments of a Forest Fire Extinguisher and Prevention System 600 may further be comprised of a forest fire detection device(s) 35. The forest fire detection device 35 may be comprised of one or more or combination of one or more sensors that may have the ability of detecting a forest fire, alert/notify the public and fire department via a website, mobile app, and/or a control room. The forest fire detection device 35. May have the ability of measuring or otherwise sensing any characteristic of a starting or already started forest fire. For example, smoke, ash, heat, and humidity. The forest fire detection device 35. May comprise, for example, one or more of a more IR sensor 15a, temperature sensor 15b, cameras and optical sensor 15c, humidity sensor 15d, smoke and ash sensor 15f, air quality sensor 15m, thermal sensor 15g, position sensor 15n, open/close sensor 15k, for example webcams, or closed-circuit television.

The forest fire detection device(s) 35 may be manufactured by any kind of material that may have the capability to withstand the heat/flames, forest fire, strong winds, and may have the capability of protecting the interior parts of the forest fire detection device(s) 35. The purpose of the forest fire detection device(s) 35 is to detect a forest fire, gather data, send an alert to the public, fire department, and/or operator/user, provide recommendations to the user such as adjusting what angle the spray device 500 should be rotated to effectively extinguish the forest fire, the water pressure that should be used, the amount of water that should be used, and if activation of surrounding spray devices should be used/activated in order to extinguish/prevent the forest fire and the spread of the forest fire.

The forest fire detection device 35 may have the ability of detecting when humidity level, heat, and the air quality reaches a certain level or condition of dryness that the forest would be more vulnerable and prevalent to start or on starting a forest fire.

Another aspect of the forest fire detection device 35, may be the visual aspect of the forest fire detection device 35. For example, a firefighter and/or operator may have the ability to view how fast the forest fire is spreading, the direction of the forest fire, and determine the growth of a forest fire by providing the user the ability to view and measure the heat signatures from the forest fire detection device(s) 35, and spray device 500. Embodiments of the system 600 may further comprise a spray device 500. The spray device 500 may be further comprised of a bead 100, a sprayer 200, a rotating mechanism 300, and a reservoir/desalinated cistern 400. The purpose of the spray device 500 is to also detect a forest fire, alert the public, the fire department, and/or an operator/user, extinguish and prevent a forest fire by spraying water onto the forest fire.

### Detailed Description of the Embodiments of the Spray Device

Embodiments of the forest fire extinguisher and prevention system 600, may further comprise of a Spray Device 500. The spray device 500 may be comprise of a head 100, a sprayer 200, a rotating mechanism 300, and a reservoir/desalinated cistern 400. The main purpose of the spray device 500 is to extinguish forest fires and prevent the start of a forest fire, as well as the spread of an active forest fire.

Embodiments of the spray device 500, may further comprise of a head 100. The head may be located on the top part of the spray device 500. The reason the head 100 may be located on the top of the spray device 500 is because the height provides a better and easier way for this system to detect a forest fire. The head 100 may be responsible for detecting a forest fire similarly the same way the forest fire detection device(s) 35 can. The head 100 may be comprised with similar sensors as the forest fire detection device 35 has such as: an infrared (IR) sensor 15a, temperature sensor 15b, cameras and optical sensor 15c, humidity sensor 15d, smoke and ash sensor 15f, and air quality sensor 15m, thermal heat sensor 15g, and a position sensor 15n. The placement of the head 100, along with the sensors inside of the head 100 is important far detecting a forest fire from a different angle, perspective, and/or point of view.

Embodiments of the head 100 may further comprise a webcam(s) 13. The webcam(s) 13 may consist of one or more of a video camera, a closed-circuit television, and/or a closed-circuit camera. The webcam(s) 13 may have the ability to provide a live feed or live stream to the public, fire department, and/or an operator/user to have a live visual perspective of an active forest fire. The webcam(s) 13, may have the ability to transmit a 360-degree live visual perspective surrounding the view of the system. In other words, anyone who has access to view or use the webcam(s) 13, may be able to view the forest fire from the system's 500 point of view.

Embodiments of the head 100 may further comprise a Mounting bracket 14. The mounting bracket 14 may be located either on the head or the top or bottom of the sprayer 200. The mounting bracket 14 may be a circular or any shape that may have the capability of supporting or keeping the embodiments of the sprayer 200 stabled and/or secured. The mountain bracket 14 may have the capability of keeping the spray head(s) 20 stationary when the activation of the rotation of the sprayer head(s) 22 when rotating. For example, when the fire department, and/or the operator/user sends a command to rotate the spray device 500 to align itself to the forest fire, the mounting bracket 14 keeps the spray head(s) 22 stable when the rotating mechanism.

Embodiments of the spray device 500, may further comprise a sprayer 200. The sprayer 200 may be of a shape, and structural design consistent with protecting the interior of the sprayer 200. Allowing the embodiments within the sprayer 200 to be rotated by a rotating mechanism 300. The sprayer 200 may be constructed and designed to withstand the heat of a forest fire, and strong winds. The purpose of the sprayer 200 is to act as an outer shell/case. Meaning the sprayer 200 may be the 2nd layer of protection for the embodiments that may reside within the sprayer 200.

Embodiments of the sprayer 200 may further comprise sensors 15. The sensors may be one or more sensors working together. For example, a malfunction detection sensor 15u detects a problem with one of the distribution device(s)/sprayer head(s) 22. A communication sensor 15l, may have the ability to communicate to the user when the rotation of distribution device(s)/sprayer head(s) 22 is complete.

The sprayer 200 may be designed to have one or more exit holes and/or connecting outlets that may allow the distribution device(s)/sprayer head(s) 22 to disperse, shoot, spray water, to the detected forest fire The sprayer 200 may have a height that is taller than the trees that are native to the area where the system 600 may be placed and/or used. For example, a native tree in California called the ponderosa pine has a height of 200 feet. The sprayer 200 may be over 200 feet to reach the surrounding trees when spraying water onto the detected forest fire.

Embodiments of the Sprayer 200 may further comprise a Conduit(s) 12. The conduit(s) 12 may be one or more of a tube, pipe, hose, cylinder, or any other elongated hollow member that may have the capability of facilitating the transport of water therethrough. The conduit 12 may have a first end 12a that may be coupled to the reservoir/desalinated cistern 400. The conduit(s) 12, may have one or more second end(s) 12b that may be coupled to the distribution device(s)/sprayer head(s) 22. The coupling of the conduit 12 to the reservoir/desalinated cistern 400 may be such that the water may exit the reservoir 400 and reach distribution device(s)/sprayer head(s) 22 to disburse/spray water onto the detected forest fire, whenever the spray device command from either the fire department and/or an operator/user. The length of the conduit(s) 12 may be the length of the sprayer 200, along with reaching the water inside the reservoir/desalinated cistern 400, and possibly enough for extension of the spray device 200, prayer head(s) 22.

Embodiments of the sprayer 200 may further comprise a Distribution case/shell 24. The purpose of a distribution shell/case 24 is for keeping the structure of the distribution device(s)/sprayer head(s) 22 secured. The distribution shell/case 24 may also be capable of protecting the distribution device/sprayer head(s) 22 when the operator/user activates the extension of the spray device 500. Providing protection to the distribution device(s)/sprayer head(s) 22 from birds or any sort of debris that may damage or impact the distribution device(s)/sprayer head(s) 22.

Embodiments of the Sprayer 200 may further comprise a Working Piston (Ram) 20 and a working cylinder 21. The purpose of a working piston (ram) 20 and a working cylinder 21 is that it may allow the spray device 500 to reach a higher altitude, by extending the interior of the sprayer 200, such as the distribution device(s)/sprayer head(s) 22, providing more ground coverage and possibly more distance by using extra power that may be already stored in an energy/power storage system 50. The working piston (ram) and the working cylinder 21 may have the ability to extend and retract the working piston (ram) 20 and a working cylinder 21 may have the ability of being rotated by a rotating mechanism 300. The extension of the spray device 500 may have one or more altitude settings that the operator/user may choose from. For example, if the forest tire detection device(s) 35 and/or the spray device 500 detects the height of forest fire is greater than the height of the spray device 500, the system 600 may recommend extending the height of the spray device 500 to extinguish/prevent the forest fire and the spread of the forest fire.

Embodiments of the Sprayer 200 may further comprise a Distribution Device(s)/Sprayer Head(s) 22. The purpose of a distribution device(s)/sprayer head(s) 22 is for the disbursement of water onto the forest fire. The distribution device(s)/sprayer head(s) 22 may comprise of one or more of a sprinkler, nozzle, spout, spigot, or anything that may function as an outlet for directing the flow of water from the reservoir/desalinated cistern 400, through the conduit(s) 12, and out from the distribution device(s)/sprayer head(s) 22 to spray water to the detected forest fire in order to extinguish/prevent the forest fire and prevent the spread of the forest fire. The distribution devices)/sprayer head(s) 22 may have one or more outlets that may be connected to the distribution case/shell and/or the sprayer 200. The distribution device\sprayer head(s) 22, may be coupled to either a single conduit 12 or multiple conduits 12. The distribution device(s)\sprayer head(s) 22 may be stacked on top of one or more distribution device(s)/sprayer head(s) 22. This may allow the spray device 500 to spray more water rather than having just a singular spray of water onto the forest fire The distribution devices)/sprayer head(s) 22 may be one or more distribution device(s)/sprayer head(s) 22. Each distribution device(s) sprayer head(s) may be responsible for covering a quarter of the perimeter. For example, a forest fire detection device(s) 35 and/or spray device 500 detects a forest fire in one of the quarters that a single distribution device(s)/sprayer bead(s) 22 is responsible for. The operator then activates the spray device 500, but only activates the distribution device(s)/sprayer head(s) 22 that is responsible for that section.

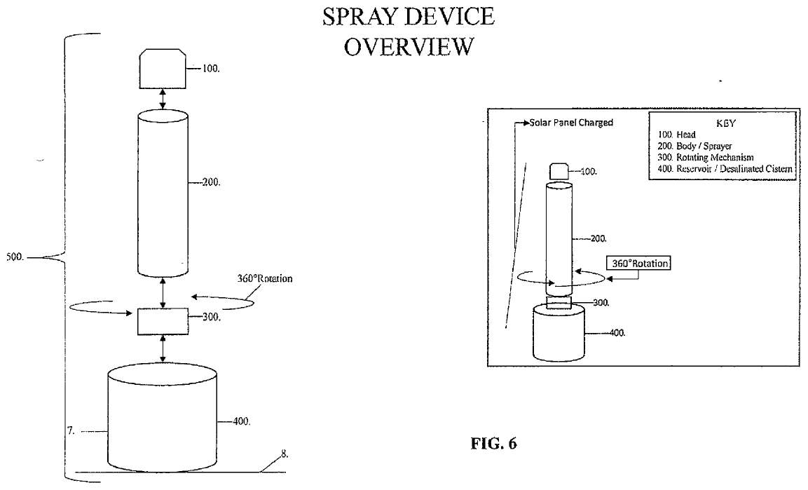

A benefit of this is that this allows the system 600 to conserve water, eliminating the number of times you would need to refill the spray device 500. To better extinguish/prevent a forest fire using one distribution device(s)/sprayer head(s) 22, more power may be required, which referring to FIG. 6 the extra power used on a singular distribution device(s)/sprayer head(s) 22 isn't much of a problem as the power may be restored by the use of solar panels 26 and the power stored in an energy/power storage system 50. Another benefit of having each distribution device(s)/sprayer head(s) 22 being responsible of a quarter of the perimeter of the spray device 500 is whenever the system 600 recommends using 2 or more distribution devices)/sprayer head(s) 22 to work together in order to better assist the extinguishment and prevention of the forest fire, that is detected within the area/section/responsibility that one of the distribution device(s)/sprayer head(s) 22 is responsible of, by having a rotating mechanism 300 that may have the ability of rotating the interior parts of the sprayer to angle 2 or more distribution device(s)/sprayer head(s) 22 onto the area/section that one the distribution device(s)/sprayer head(s) 22 is responsible of.

Another benefit of having 2 or more distribution device(s)/sprayer head(s) 22, is for example, whenever a malfunction detection sensor 15u detects a malfunction in the one of the distribution devices(s)/sprayer head(s) 22, while there's an active forest fire detected in the area/section that the malfunctioned distribution device/sprayer head 22 is responsible of. The spray device 500 may send an alert to the operator/user about the malfunction and recommend rotating the non-faulty distribution device/sprayer head 22 to take over the responsibility of that faulty distribution device/sprayer head 22. Allowing the continuation of extinguishing the forest fire.

Embodiments of the spray device 500 may further comprise a reservoir/desalinated cistern 400. The purpose of the reservoir/desalinated cistern 400 is to hold/store water in. The reservoir 400 may be a tank, water tank, container, chamber, or any other vessel that may be capable of holding more than 1,000 gallons of water. The reservoir 400 may be of a size, shape, and structural design consistent with holding more than 1,000 gallons of water. The reservoir 400 may be designed such that it is self-contained, or in a way that the water may be either inserted or refilled using filler 42. The reservoir/desalinated cistern 400 may be fixed in place relative to a surface/ground upon, or by which, the reservoir/desalinated cistern 400 is supported. For example, the reservoir/desalinated cistern 400 may be set on or below the surface, such as the ground, and left in place. Alternatively, the reservoir/desalinated cistern 400, may be moved or removed from one surface to another, such as one ground location to another ground location. Alternatively, the reservoir/desalinated cistern 400 and/or the spray device 500 may be a completely mobile unit. Meaning the reservoir/desalinated cistern 400 and/or the spray device 500 is not fixed or positioned permanently at any one location but is instead portable to any desired location accessible by transport.

Embodiments of the reservoir/desalinated cistern 400 may further comprise a cooling system 40. The purpose of a cooling system 40 is so that it keeps the water cool, as well as limiting the exposure of heat, slowing down the process of water evaporating. The cooling system 40 may be capable of cooling the water down by either refrigerated pipes or some sort of a water-cooling system. The cooling system 40 may also be used to keep the internal embodiments of the spray device 500 cool, so that it doesn't overheat. A benefit of having a cooling system 40 within the reservoir/desalinated cistern 400 is that it may be capable of protecting the internal components of the spray device 500 from overheating. Additionally, the cooling system 40 may have the ability of keeping the spray device cool. In other words, keep the temperature of spray device 500 at working temperature if this system is placed in areas/locations that are known to have a higher heat temperature.

Embodiments of the reservoir 400 may further comprise a sensor(s) 15. The sensor(s) 15 is not restricted to only one sensor. For example, a temperature sensor 15b may be used to read the temperature inside of the reservoir/desalinated cistern 400 water temperature sensor 15z. Another a sensor may be a water level sensor 15w, which may have the ability to gather data such as the amount of water left inside the reservoir/desalinated cistern 400, transmit the data onto the database, display the data that the water level sensor 15w collected, and allowing the operator/user to view, monitor how much water is left within the reservoir/desalinated cistern 400 via a mobile app, website, and/or control room.

A sensor 15 within the spray device 500 may have the ability to predict/assume/measure how much power to use when there is a certain amount of water left inside the reservoir/desalinated cistern 400. For example, a mobile app may have the ability of displaying the water level inside of the spray device 500 as well as provide that the water level sensor 15w detected that there is a low amount of water within the reservoir/desalinated cistern 400. The spray device 500 may have the ability to calculate the distance of the forest fire and the amount of power needed to spray water onto the forest fire with the low amount of water that is inside of the reservoir/desalinated cistern 400.

Embodiments of the reservoir 400 may further comprise a filler 42. The filler 42 may consist of one or more combinations of, a water filler, filler neck and/or filler tube. The purpose of the water filler 42 allows the system 500 to be refilled with either water. In other words, If the water level sensor 15w detects that the amount of water inside the reservoir/desalinated cistern 400 is low, you may fill the reservoir/desalinated cistern 400 with water using the filler that may be located on the reservoir/desalinated cistern 400.

Embodiments of the spray device 500 may further comprise of a rotating mechanism 300. The purpose of a rotating mechanism 300 is to rotate the sprayer and/or the interior of the sprayer 360 degrees. The rotating mechanism 300 may be programed or configured to rotate, or otherwise move in a circular direction, 360 degree, such that, a malfunction occurs, the rotating mechanism 300 may rotate the sprayer/interior of the sprayer 200 allowing one of the functional distribution device's/sprayer head's 22 replace the area/section that was responsible by the malfunctioned distribution device/sprayer head 22.

What is claimed is:

1. A system and method for extinguishing and preventing forest fires and the spread of a forest fire via the use of a forest fire detection device and a spray device

2. A Forest Fire Detection Device that contains either one or more or combination of sensors such as that may detect a forest fire, use historical weather data and the weather data provided from the spray device and the forest fire detection device to spray water onto the forest so that the forest may be hydrated/moisturized.

3. A spray device that has the ability to communicate with the public, fire departments, and/or operator/user via a Mobile App, website, and/or control room. The Activation of a spray device via a mobile app, website, and/or control room.

4. A spray device that has the ability to extend itself to cover more ground.

5. A spray device comprising of: A Reservoir that contains water, or any sort of fluid that may be used to extinguish and prevent forest fire/wildfires, a cooling system inside the reservoir to keep the water away from evaporating, a rotating mechanism to rotate the interior of the sprayer 360 degrees, a sprayer that may contain embodiments such as: Distribution device/sprayer heads, Distribution case/shell, Working Piston (Ram), Working cylinder, Conduits, Sensors—such as An infrared (IR) sensor, a temperature sensor, a camera, optical sensor, a Humidity sensor, a smoke, gas, and air quality sensor, a thermal sensor, ultraviolet (UV)/JR sensor, a JR/JR3 flame detection sensor, an open/close sensor, a position sensor, a predictive maintenance sensor that may be comprised of a current sensor, a thermocouple sensor, a vibration sensor.

6. A system and method of providing accurate location, movement of the forest fire via a forest fire detecting device(s) and spray device. The spray device and forest fire detection devices having the ability of collecting live data that may be stored in a database and may be accessed by a mobile app, website, and/or control room. The use of live data collected from the forest fire detecting device(s) and the spray device, providing recommendations to an operator/user.

7. A system and method of using extinguishing and preventing a forest fire and the spread of a forest fire comprises of the use of a conduit(s) that are between in between the head and desalinated cistern/reservoir to carry the water located within the desalinated cistern/reservoir up to the sprayer and spray water onto the forest fire to extinguish/prevent a forest fire and the spread of a forest fire.

8. A system and method of using extinguishing and preventing a forest fire and the spread of a forest fire comprises of the use of a control board that may have the capability of having control of sensors, motors, water, desalination.

9. A system and method of using extinguishing and preventing a forest fire and the spread of a forest fire comprises of machine learning such as predictive algorithms, regression analysis based on historical weather data for LAT/LONG of spray device

10. A system and method of using the data stored/provided from the data base to have data analytics such as risk areas (MAP), recommend actions, real-time control (devices), and regional response to extinguish/prevent a forest fire and the spread of a forest fire.

11. A system and method of using extinguishing and preventing a forest fire and the spread of a forest fire comprises of the database. The database may have the capability of providing a device ID, sensor ID, sensor values, LAT/LONG or distance, forest fire detecting device status, spray device status, spray device water level, spray device salination/desalination level, spray device power charge level.

12. A spray device that has the ability of extending the distribution device(s)/sprayer head(s) to be able to have a higher altitude to have a greater reach for the water to extinguish a forest fire.
